(19) United States
(12) Patent Application Publication
(10) Pub. No.: US 2002/0101926 A1
(43) Pub. Date: Aug. 1, 2002

(54) Block matching motion estimator reducing its clock cycles and method thereof

(76) Inventor: Jong-Seong Yoon, Seoul (KR)

Correspondence Address: STAAS & HALSEY LLP, 700 11TH STREET, NW, SUITE 500, WASHINGTON, DC, 20001, US

(21) Appl. No.: 09/750,179

(22) Filed: Dec. 29, 2000

(30) Foreign Application Priority Data
Dec. 15, 2000 (KR) 2000-77089

(51) Int. Cl. H04N 7/12

(52) U.S. Cl. 375/240.12; 375/240.24; 375/240.01

(57) ABSTRACT

A block matching estimation apparatus and a method thereof are disclosed. The block matching estimation apparatus includes a first predetermined number of first processor, each of which receives a search data at a rising edge of a clock, for calculating an absolute difference value between the search data and a reference data; and the first predetermined number of second processor, each of which receives a search data at a falling edge of the clock, for calculating an absolute difference value between the search data and a reference data, wherein the first processor and the second processor are alternately connected. The block matching estimator can decrease its the clock cycles by performing operations at the rising edge and the falling edge of the clock.

### FIELD OF THE INVENTION

The present invention relates to a block matching motion estimator and a method thereof; and, more particularly to a block matching motion estimator reducing its clock cycles and a method thereof which perform two operations in one clock cycle, i.e., one in a rising edge and one in a falling edge.

### DESCRIPTION OF THE PRIOR ART

A block matching algorithm is widely used as a motion estimating algorithm for deleting correlation between video data frames.

The block matching algorithm divides frames which are timely adjacent to a fixed block and estimates movement of the corresponding block.

A full-search block matching algorithm (FBMA) has the best matching capability in the block matching motion estimating algorithm. In here, the FBMA is expressed by equations (1) and (2) as following.

$$SAD ( u , v ) = {\sum }_{i = 0}^{N - 1} {\sum }_{j = 0}^{N - 1} \vert s ( u + i , v + j ) - r ( i , j ) \vert , - d \leq u , v \leq + d \qquad ( 1 )$$

Where, SAD represents sum of absolute difference.

V=(u,v)|min SAD(u,v) (2)

The FBMA calculates sum of absolute difference (SAD) within search range from −d ˜+d, compares the SAD each other and choose a block which has minimum SAD. Generally, a reference block size (N) and a search range (D) have different horizon value and vertical value but hereby determined to same value for convenience sake and the SAD is used as a matching measure.

The FBMA has simplicity and regulation in operation so good in realizing of hardware and has the best capability, whereas has numerous operations.

FIG. 1 is a diagram illustrating a general motion estimator. As described in FIG. 1, the motion estimator comprising a search area data buffer 110 which stores a search area data (sdata) 111, motion estimator 120 which calculates motion estimating and a reference block data buffer 130 which delays a reference block data 131.

The sdata 111 and a reference block data (idata) 131 are input to the motion estimator to output a motion vector (mvdata) 121.

The search area data buffer 110 decrease input data rate of the sdata 111 by storing the former sdata 111 and the current sdata 111 in former stage and current stage respectively and easily response to the various data request according to the motion estimator VLSI architecture.

Additionally, the reference block data buffer 130 is functioned as a data rate buffer with the search area data buffer 110 and delay the idata 131 and then, at the same as the pdata 112, output them to the odata 132.

The motion estimator 120 actually calculates motion estimating, and according to its VLSI architecture, the sdata 111 or the idata 131 is required one or more data per a clock cycle. And in some cases, it requires the same data one or more times.

Also the motion estimator 120 architecture has an array of processing elements (PE) thereby has a hardware architecture which carry out operations as many as multipled the number of search block and the number of reference block data. And generally, a given number of clock cycles has smaller than that of operation, so numeral PE performing parallel operations.

FIG. 2 is a diagram showing a motion estimation VLSI architecture which general PE operation.

As described in FIG. 2, the PE 210 inputs an a 211 and a b 212 to output an absolute value of the a 211 minus the b 212.

FIG. 3 is a diagram showing a motion estimation VLSI architecture which is one-dimensional PE array architecture with a column of the PE 311 to 314 in accordance with a first preferred embodiment of the present invention.

Referring to FIG. 3, a motion estimation VLSI including the PE 311 to 314 which calculate an absolute difference of input data, an adder tree 320 which add the PE 311 to 314 outputted absolute differences, simultaneously, an accumulator 330 which accumulate the adder tree 320 outputted sums of absolute difference (SAD) and a comparator 340 which calculate the minimum SAD from the accumulator outputted accumulated SAD.

In the SAD operation, absolute differences from all the PE 311 to 314 are added through the adder tree 320, added SADs in the adder tree 320 are accumulated through the accumulator 330 and then compared with the minimum SAD through the comparator 340.

Also, different from the SAD calculating process, in another method, add absolute differences from all the PE 311 to 314 through the adder tree 320 and obtain the SAD in the final PE by transferring the absolute differences to adjacent processing element and accumulate it in the PE, but this method has no advantage in hardware complexity.

However, the present invention doesn't affected by the SAD operation circuit.

The PE structure of one-dimensional array has an advantage of having 100% operation clock efficiency. However, in this structure, the sdata 111 and the idata 131 is provided as many as the number of PE, in each clock cycle, so a buffer architecture and a supply circuit of the search area data buffer 110 and the reference block data buffer 130 are complicated. Accordingly, if the motion estimator has many PEs, one-dimensional array structure is not proper.

FIG. 4 is a diagram showing a motion estimation VLSI of a second preferred embodiment of the present invention and, thereby having two-dimensional PE architecture which increasing process element number without increasing an input bandwidth of the sdata 111 and the idata 131.

Referring to FIG. 4, the sdata s0, s1, s2 and s3 and the idata i0, i1, i2 and i3 are loaded to an internal latch of a processing element (PE) 401 to 416 for four clock cycles. Hereafter, the sdata s0, s1, s2 and s3 and the idata i0, i1, i2 and i3 are still latched to the PE 401 to 416, and the sdata s0, s1, s2 and s3 are carried out an absolute different operation by right shift, and add the absolute differences in an adder tree 420, then obtain minimum SAD by comparing the SAD in a comparator 430.

The disadvantage of the above structure is a waste of clock cycles by loading and a large data bandwidth as many as that of PE rows.

FIG. 5 is a diagram showing a motion estimating VLSI of a third preferred embodiment of the present invention and, thereby simplify the conventional data supply structure by having two dimensional structure of N×N processing element and (2d)×(N−1) latch. In here, N denotes a reference block size and d denotes a search range.

Referring to FIG. 5, the reference data (i) is inputted during N×N clock to load in the processing element 501 to 516 and the search area data close its operation by inputting the last search area data.

Then the SAD of one search area in each clock is obtained and at the same time, optimum search block comparison is processed.

The above structure has simple data input structure, but on the other side, lots of latch 520 to 531 and loading clock is needed.

FIG. 6 is a diagram showing a motion estimating VLSI which using general block matching motion estimating algorithm in accordance with a fourth preferred embodiment of the present invention and, thereby the processing element performing an absolute difference operation and charge the SAD operation in each search block.

As described in FIG. 6, every SAD of the search block is obtained when every search block data is inputted and a clock cycle is used to search optimum search block by extract the SAD from the every processing element 601 to 625.

The number of PEs 601 to 625 is related to a number of the search block and a latch number is determined by a horizonal reference block data number and a vertical search block number.

Therefore, the above structure is apt to a motion estimator which have small search block, e.g., a half per unit element motion estimation which is carried out after an integer per unit element motion estimation in MPEG-2.

The structures in FIG. 2 or FIG. 3 have good efficiency in calculation but data supply structure is complicated, the structures in FIGS. 4 and 5 have simple data supply but need many cycles.

### SUMMARY OF THE INVENTION

It is, therefore, an object of the present invention to provide a block matching motion estimator reducing its clock cycles and a method thereof.

In accordance with one aspect of the present invention, there is provided a block matching estimation apparatus including a first predetermined number of first processor, each of which receives a search data at a rising edge of a clock, for calculating an absolute difference value between the search data and a reference data; and the first predetermined number of second processor, each of which receives a search data at a falling edge of the clock, for calculating an absolute difference value between the search data and a reference data, wherein the first processor and the second processor are alternately connected.

In accordance with another aspect of the present invention, there is provided a block matching estimation method, comprising the steps of: a) receiving a reference signal and two search datas at a clock; b) calculating absolute difference values between the search data and a reference data at a rising edge; and c) calculating absolute difference values between the search data and a reference data at a falling edge.

### BRIEF DESCRIPTION OF THE DRAWINGS

The above and other objects and features of the present invention will become apparent from the following description of the preferred embodiments given in conjunction with the accompanying drawings, in which;

FIG. 1 is a diagram illustrating a general motion estimator;

FIG. 2 is a diagram showing a general PE processor;

FIG. 3 is a diagram showing a conventional motion estimation architecture;

FIG. 4 is a diagram showing another conventional motion estimation VLSI;

FIG. 5 is a diagram showing a further another conventional motion estimation VLSI;

FIG. 6 is a diagram showing a still another motion estimation VLSI;

FIG. 7 is a diagram showing a block matching motion estimation VLSI for reducing its clock cycles in accordance with a preferred embodiment of the present invention;

FIG. 8A is a detailed diagram showing a processing element of FIG. 7;

FIG. 8B is a diagram showing a minimum sum of absolute difference (SAD) operation processing in accordance with a preferred embodiment of the present invention; and

FIG. 9 is a timing diagram showing a block matching motion estimation VLSI in accordance with a preferred embodiment of the present invention.

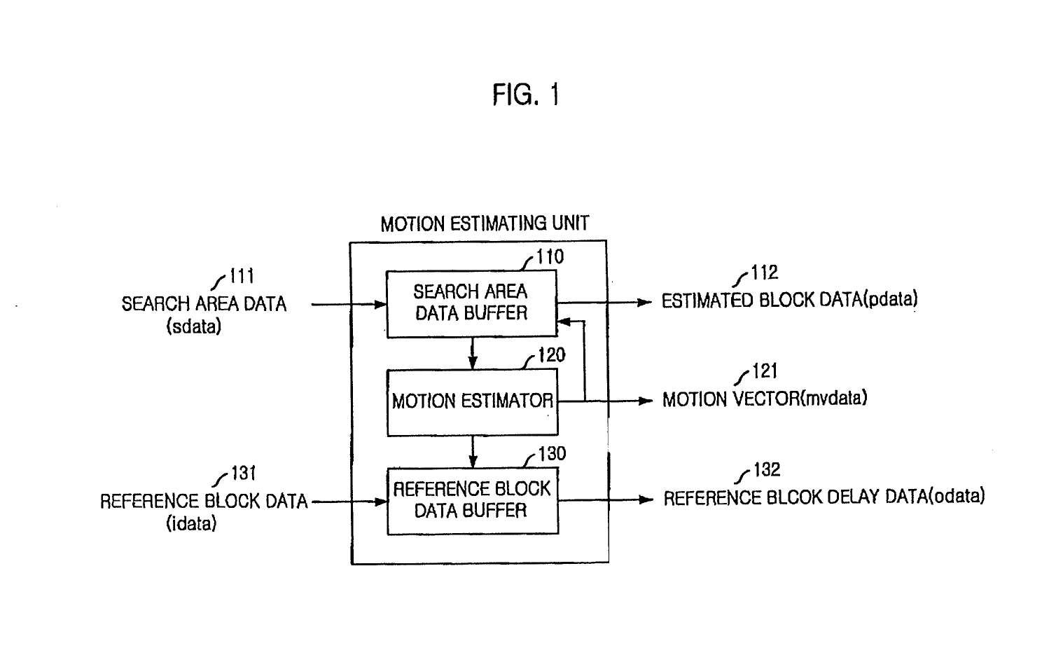

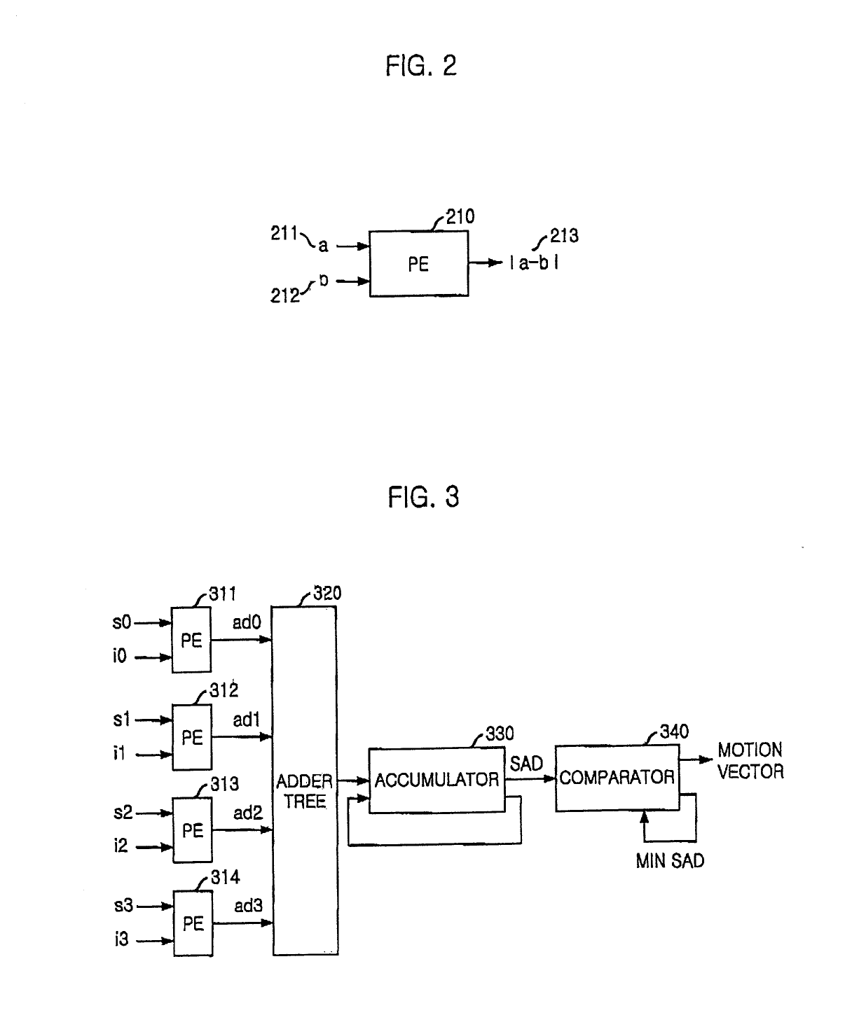

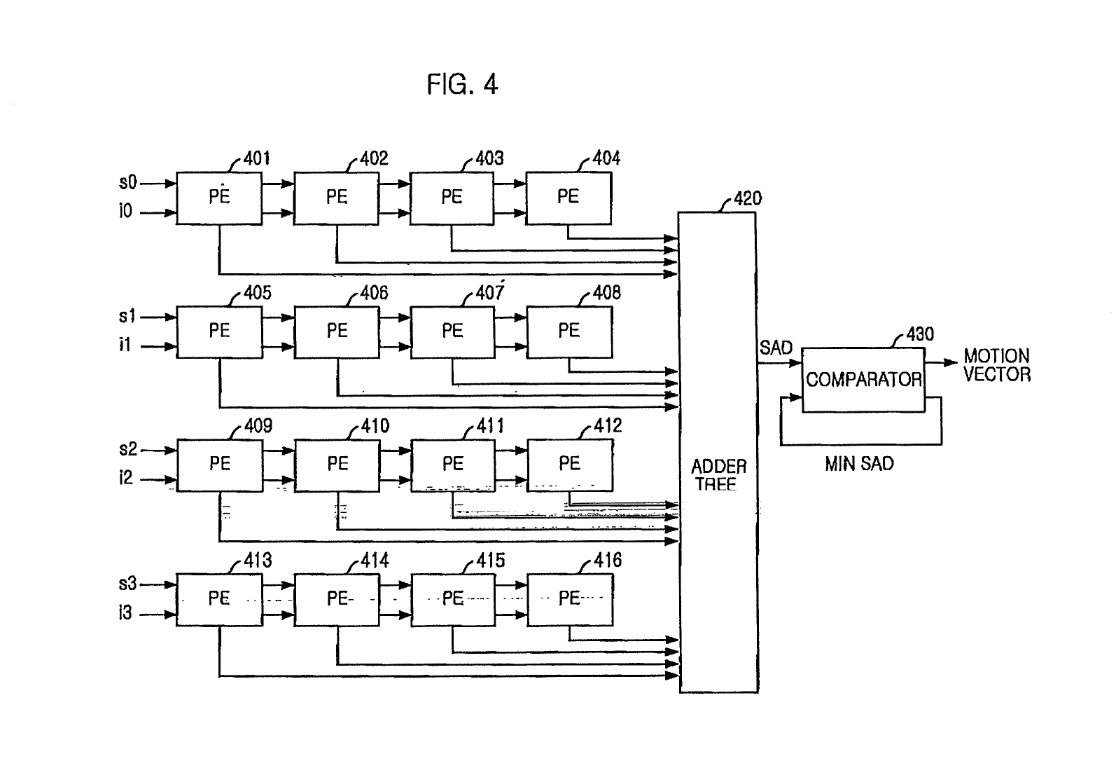

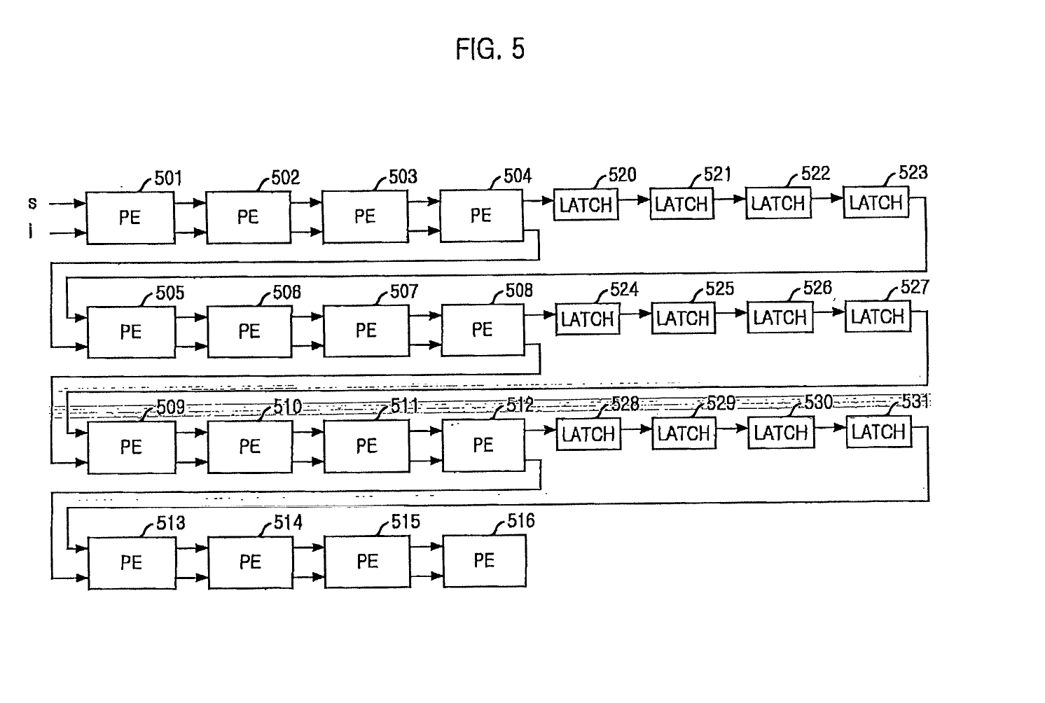

### DETAILED DESCRIPTION OF THE PREFERRED EMBODIMENTS

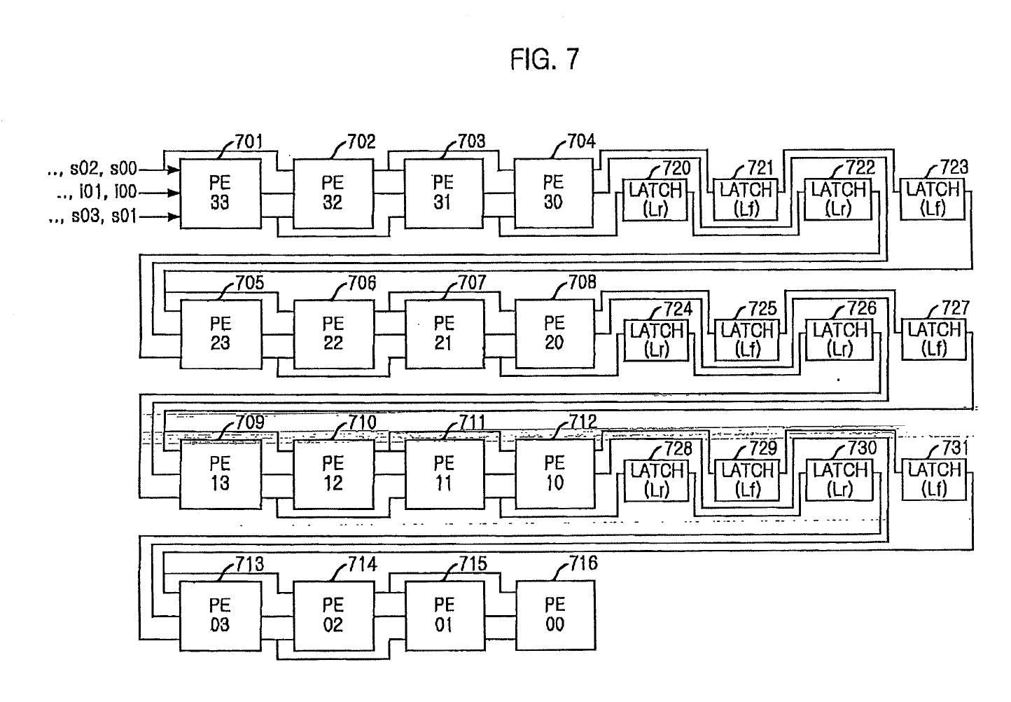

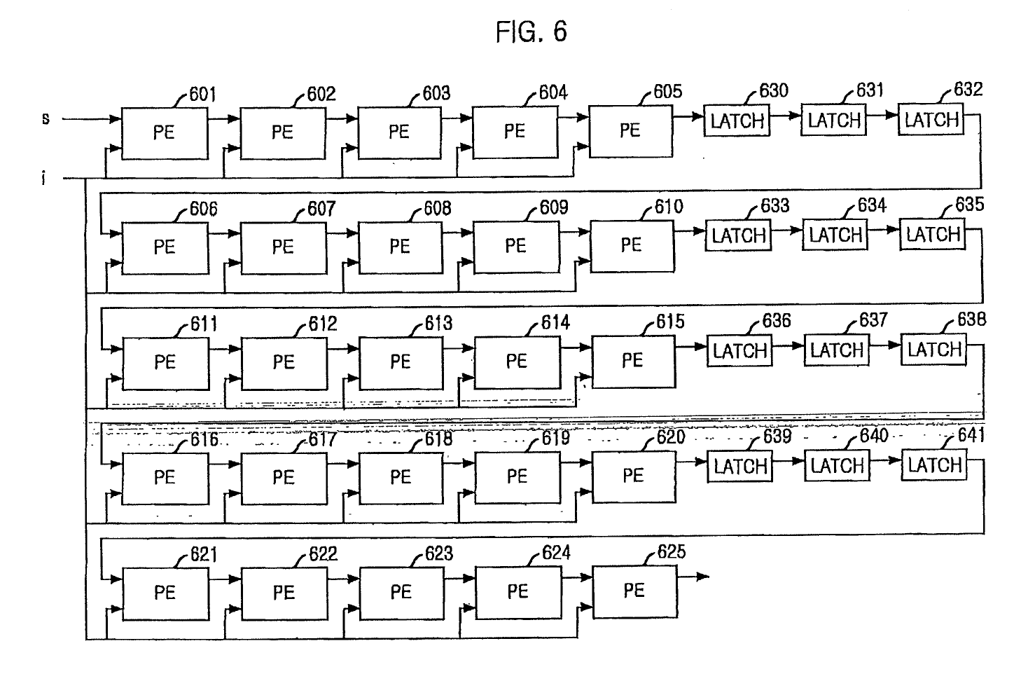

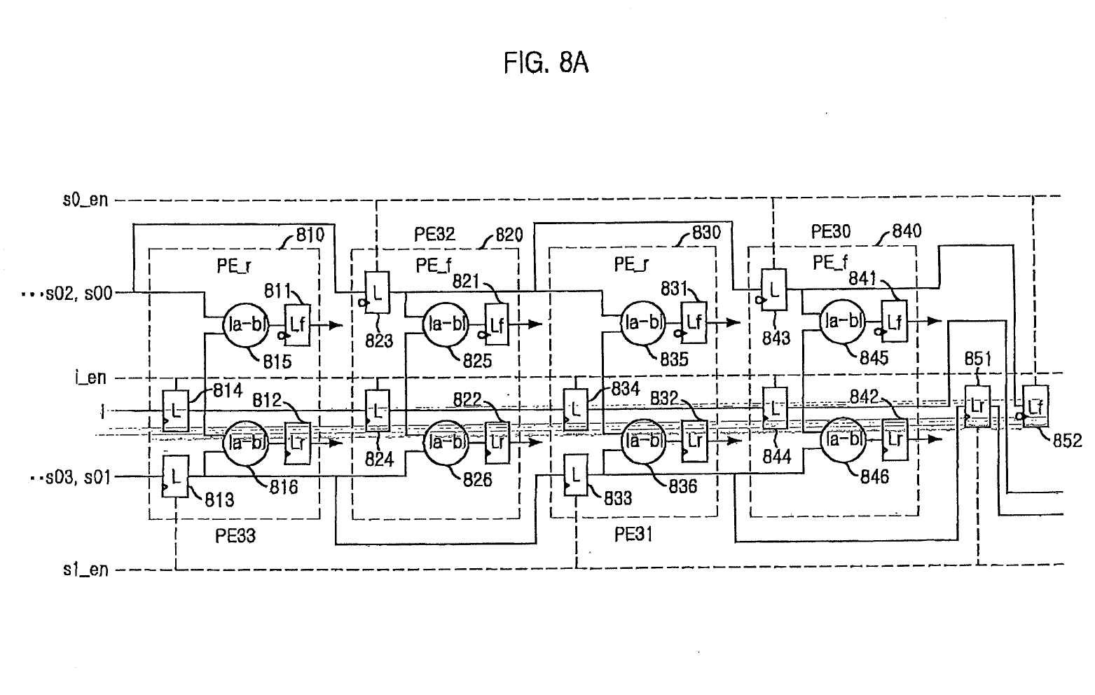

FIG. 7 is a diagram showing a block matching motion estimation very large scale integration (VLSI) for reducing its clock cycles in accordance with a preferred embodiment of the present invention, which is adopted to a motion estimation VLSI architecture in FIG. 5.

As described in FIG. 7, the block matching estimating VLSI for reducing clock cycles includes a processing element (PE) 701 to 716 which performing unit calculation and an outer latch (Lr, Lf) 720 to 731 which performing a shift function for aligning unifying a data in case of transferring a data of PE data to next PE.

The VLSI has two-dimensional PE architecture N×N processing element and (2d)×(N−1) latchs as in the FIG. 5. In here, N and d denotes sizes of a reference block and searching region, respectively.

The search area data (s00, s01, s02 and s03) per cycle are input in a rising edge (s00, s02, . . . ), in a falling edge (s01, s03) of the clock by ones, so two is input per clock cycle and at this time, the search area data is transferred in two per cycle.

The specific architecture and operation of the PE 701 to 716 and the outer latch 721 to 731 is as below.

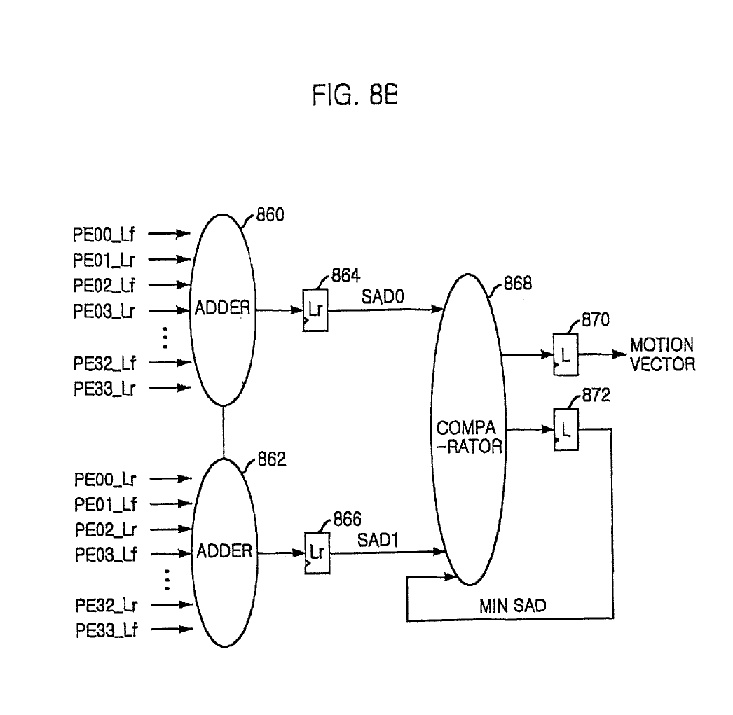

FIG. 8A is a diagram showing a VLSI for reducing a clock cycle number in accordance with a preferred embodiment of the present invention and describes an inter architecture of the PE and connection between PEs.

As described in FIG. 8A, a processing element for reducing clock cycles in VLSI is comprising a rising edge processing element PE_r (PE33, PE31) 810 and 830 and a falling edge processing element PE_f (PE32, PE30) 820 and 840 for using each edge (rising edge and falling edge), and the processing elements are connected alternately from the PE33 701 to PE00 716.

The inter architecture of the PE is comprising a latch 813, 823, 833, and 843 for loading the search area data s00, s01, . . . , a latch 814, 824, 834 and 844 for loading a reference block data (i), an absolute difference calculator 815, 816, 825, 826, 835, 836, 845 and 846 for calculate the i difference, a latch 812, 822, 832 and 842 for loading the rising edge calculated absolute difference and a latch 811, 821, 831 and 841 for loading the absolute difference calculated at the falling edge.

The detailed description of the VLSI operation for reducing clock cycles by adapting to a block matching motion estimation algorithm is as below.

First of all, the i is input by one data per clock cycle during 16 clocks and loaded to each PE latch 814, 824, 834 and 844 and the search area data s00, s01, . . . is input by two data (at the rising edge and the falling edge, respectively) per clock cycle so that they move by two blocks per a cycle.

The every i is loaded by the above processing and when the search area data is input to the processing element PE00, the absolute difference calculator 815, 816, 825, 826, 835, 836, 845 and 846 calculates an absolute difference.

In case of an odd number processing element PE33, PE31, . . . the absolute difference calculation is processed by calculating absolute differences between the i loaded in the odd number processing element PE33, PE31, . . . latch 814 and 834 the i and even number data s01, s03, . . . of the search area latch 813, 833, then store the value to the Lr 812, 832 and then calculate an absolute difference between the i data and s00, s02 . . . , of the search area and store it to Lf 811, 831.

In case of an even number processing element PE32, PE30, the absolute difference calculation is processed by calculating absolute differences between the even number processing element PE32, PE30, . . . latch 823 and 843 loaded the i and an even number data s00, s02, . . . of the search area latch 823, 843, then store the value to the Lf 821, 841 and then calculate an absolute difference between the i data and s00, s02 . . . , of the search area and store it to Lr 822, 842.

The SAD is obtained by the above obtained absolute difference values 811, 812, 821, 822, 831, 832, 841 and 842 and the process obtaining SAD will be described in FIG. 8B.

FIG. 8B is a diagram showing a minimum sum of absolute difference (SAD) operation processing in accordance with a preferred embodiment of the present invention.

The absolute difference value 811, 812, 821, 822, 831, 832, 841 and 842 which are obtained in FIG. 8A is inputted an accumulator 860 and 862 then the SADs of two search block per a clock are obtained.

In a first clock, the latch value Lr 812 and 832 of the absolute difference value of the odd processing element PE33, PE31, . . . and the latch value Lf 821 and 841 of the absolute difference value of the even processing element are added in an accumulator 860 then, a SAD of a first search area SAD0 is obtained. And the latch value Lf 811 and 831 of the absolute difference value of the odd processing element and the latch value Lr 822 and 842 of the absolute difference value of the even processing element are added in an accumulator 862 then, a SAD of a second search area SAD1 is obtained. In here, the SAD is compared in a comparing machine 868 to calculate a minimum SAD and a motion vector for estimating motion is determined.

After that, clock cycles in which only loading occurs are existed, but by inputting final search area data, a final SAD is calculated and motion estimating calculation is end.

The internal latches 823 and 843 of the processing element PE_f, the internal latches 813 and 833 of the processing element PE_r and the reference block data latches 814, 827, 834 and 844 are latched by an enable signal “s0_en”, “s1_en” and “i_en”, respectively. At this time, the processing element PE_f and an outer latch Lf 852 is latched according to the enable signal “s0_en” and the processing element PE_r and an outer latch Lr 851 are latched according to the enable signal “s1_en”.

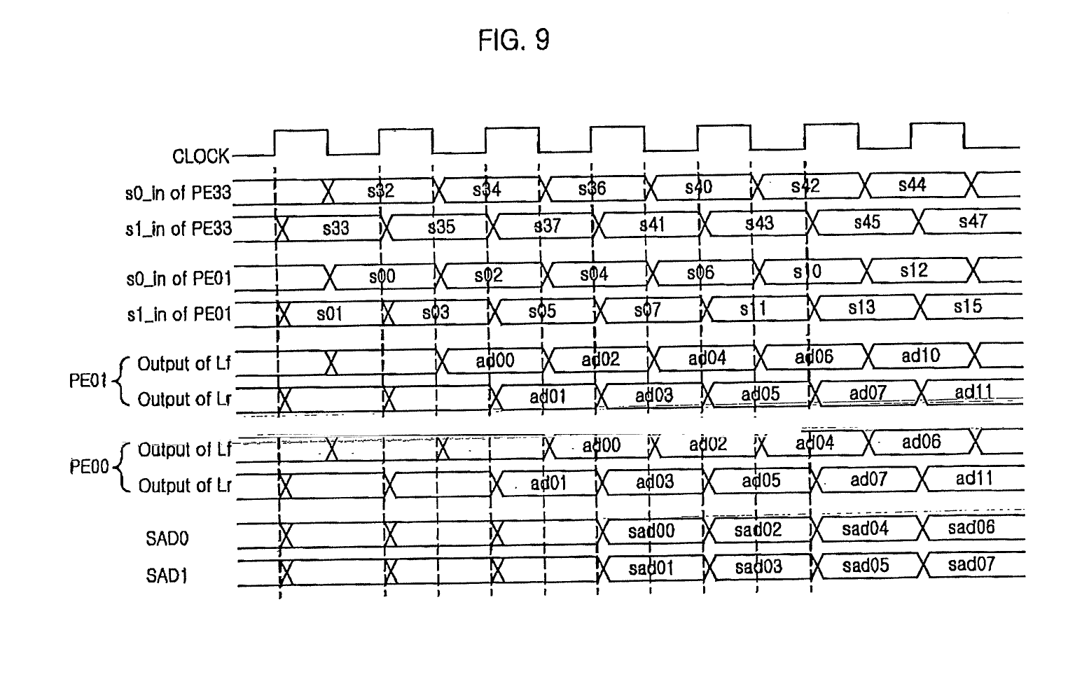

FIG. 9 is a diagram showing a block matching motion estimating VLSI in accordance with a preferred embodiment of the present invention.

As described in FIG. 9, a search area (sdata) is inputted through an inputting port s0 and s1 of a processing element PE33 810 in two data per one cycle.

In the s0 port, s00, s02, s04 are input and latched at an falling edge of a clock and transferred to next processing element, and in the s1 port, s01, s03, s05, . . . are input and latched at an rising edge of a clock and transferred. In here, the transfer of the sdata is always performed when a clock is triggered and there is no need to be controlled by the enable signal. However, the enable signal can decrease a consumption of power.

When the transferred sdata is reached to the processing element PE00, then the SAD is calculated by adding an absolute difference of all processing elements.

As described in FIG. 9, a data wave form of the s0_in 801 and s1_in 802 of the PE33 are input to s0 port and s1 port of the PE33 when the first data s00 and s01 of the sdata are reached to the s0_in 803 and s1_in 804 of the processing element PE01.

The internal latch Lf output and Lr output wave form 805 of the processing element are an absolute difference output timing of the PE01 and the PE00.

The latch Lf output of the PE01 describes a falling edge absolute difference data between data which are input through i01 and s0 of PE01. And the latch Lr output of the PE01 describes a search area data which inputted through the PE01 loaded i01 and s1 table, performed an absolute difference operation and latched in an rising edge of the clock.

The latch Lf output and the latch Lr output of the processing element PE00 have the same operation and in here, instead of the i01, an i00 is used. The ad00, ad01 . . . , means an absolute difference calculation with the internal block of the processing element is performed with s00, s01, . . .

The function of the SAD0(sad00) is Lf(ad00) of the PE00+Lr(ad01) of the PE01+. . . +Lf(ad32) of the PE32+Lr(ad33) of the PE33. And the function of the SAD1(sad01) is Lr(ad01) of the PE00+Lf(ad02) of the PE01+. . . +Lr(ad33) of the PE32+Lf(ad34) of the PE33. That is, two SAD is obtained per clock.

As described above, the block matching estimator in accordance with the present invention can decrease its the clock cycles by performing operations at the rising edge and the falling edge of the clock.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. A block matching estimation apparatus, comprising:
a first predetermined number of first processing means, each of which receives a search data at a rising edge of a clock, for calculating an absolute difference value between the search data and a reference data; and
the first predetermined number of second processing means, each of which receives a search data at a falling edge of the clock, for calculating an absolute difference value between the search data and a reference data,
wherein the first processing means and the second processing means are alternately connected.

2. The apparatus as recited in claim 1, further comprising:
first adding means for summing the absolute difference values of the first processing means and generating a first summation value;
second adding means for summing the absolute difference values of the second processing means and generating a second summation value; and
comparing means for comparing the first summation value with the second summation value, thereby obtaining a minimum summation of the absolute difference value (SAD).

3. The apparatus as recited in claim 2, further comprising:
a second number of storing means for storing the absolute difference values.

4. The apparatus as recited in claim 1, wherein the first processing means includes:
a first latch for loading an input data at the rising edge of the clock;
calculating means for calculating the absolute value of difference between the input data and the reference data; and
a second latch for storing the absolute difference between the input data and the reference data.

5. The apparatus as recited in claim 1, wherein the second processing means includes:
a first latch for loading an input data at the falling edge of the clock;
calculating means for calculating the absolute value of difference between the input data and the reference data; and
a second latch for storing the absolute value of difference between the input data and the reference value.

6. The apparatus as recited in claim 5, wherein the first predetermined number is selected based on a size of a reference block.

7. The apparatus as recited in claim 6, wherein the second predetermined number is (2d)×(N−1),
wherein N represents a size of a reference block and d does a size of a search range.

8. A block matching estimation method, comprising the steps of:
a) receiving a reference data and two search data at a clock cycle;
b) calculating absolute difference values between the search data and a reference data at a rising edge; and
c) calculating absolute difference values between the search data and a reference data at a falling edge.

9. The method as recited in claim 8, further comprising the steps of:
d) summing the absolute difference values of the first processing means and generating a first summation value;
e) summing the absolute difference values of the second processing means and generating a second summation value; and
f) comparing the first summation value with the second summation value, thereby obtaining a minimum summation of the absolute difference value (SAD).
